(19) United States
(12) Patent Application Publication
(10) Pub. No.: US 2017/0028739 A1
(43) Pub. Date: Feb. 2, 2017

(54) PRINTING APPARATUS AND PRINTING METHOD

(71) Applicant: MIMAKI ENGINEERING CO., LTD., Tomi-shi, Nagano (JP)

(72) Inventors: Masaru OHNISHI, Nagano (JP); Ayumi SAKAGUCHI, Nagano (JP)

(73) Assignee: MIMAKI ENGINEERING CO., LTD., Tomi-shi, Nagano (JP)

(21) Appl. No.: 15/106,832

(22) PCT Filed: Dec. 25, 2014
(86) PCT No.: PCT/JP2014/084309

§ 371 Date: Jun. 21, 2016

(30) Foreign Application Priority Data
Dec. 26, 2013 (JP) 2013-270523

(51) Int. Cl. B41J 2/21

(52) U.S. Cl. CPC B41J 2/2103

(57) ABSTRACT

There are provided an ink recording head, a printing apparatus, and a printing method that may suppress the occurrence of color smearing. An ink recording head 10 according to an aspect of the present disclosure includes ink recording heads 10 (Y), 10 (M), 10 (C), 10 (R), 10 (G), 10 (B), and 10 (K) respectively configured to record inks of yellow (Y), magenta (M), cyan (C), red (R), green (G), blue (B), and black (K).

### TECHNICAL FIELD

The present disclosure relates to a printing apparatus and a printing method, more particularly to a printing apparatus equipped with an ink recording head, and a printing method.

### BACKGROUND ART

In connection with printing apparatuses using inks (may otherwise be referred to as recording apparatuses), there are known technologies available these days that can accomplish high-quality printing (recording) without compromising native resolution.

For example, some known printing apparatuses are operable to print (record) an object to be printed in desired color tones by differently mixing color inks and/or varying proportions of the inks to be mixed. The color inks to be mixed may be yellow (hereinafter, symbol (Y)), magenta (hereinafter, symbol (M)), and cyan (hereinafter, symbol (C)) color inks.

Patent Literature 1 describes a printing apparatus in which a black ink (hereinafter, symbol (K)) is used in addition to these three color inks.

### CITATION LIST

### Patent Literature

Patent Literature 1: JP H09-286122 A (disclosed on Nov. 4, 1997)

### SUMMARY

### Technical Problem

The inventors of the present application found out that the prior art apparatuses often led to the occurrence of color smearing.

More specifically, using three color inks of yellow (Y), magenta (M), and cyan (C) or four different inks further including a black (K) ink often results in greater ink consumption in pursuit of desired color tones, needing longer drying time. During such extended drying time, the inks may be unwantedly mixed, which the inventors found to be a probable cause of color smearing.

The present disclosure, to address this issue, provides a printing apparatus and a printing method that may effectively suppress the occurrence of color smearing.

### Solutions to Problem

To this end, a printing apparatus according to the present disclosure includes: an ink recording head; and a controller configured to control the ink recording head, the printing apparatus being operable to print an optional color by way of color separation into three primary colors, wherein

the ink recording head includes recording heads configured to record inks of the three primary colors and further includes recording heads configured to record inks that exhibit medium color tones produced by mixing inks of two colors among the three primary colors, and

the controller, when the medium color tone is produced by mixing inks of two colors among the three primary colors, prompts the ink recording head to use a single color ink among the inks that exhibit the medium color tone of the two colors.

In producing a medium color tone by mixing two colors of the three primary color inks, this printing apparatus may successfully cut down on the total ink volume necessary for the wanted color tone, thereby suppressing the occurrence of color smearing.

This advantageous effect may be attained because a color tone produced by discharging, among the three primary color inks, the yellow (Y) and magenta (M) inks with the proportion of 1:1 is identical to a color tone expressed by a red color (hereinafter, symbol (R)) ink, comparable to the medium color tone, discharged in volume 1 (same volume as the yellow (Y) ink or magenta (M) ink).

Likewise, a color tone produced by discharging, among the three primary color inks, the yellow (Y) and cyan (C) inks with the proportion of 1:1 is identical to a color tone expressed by a green color (hereinafter, symbol (G)) ink, comparable to the medium color tone, discharged in volume 1 (same volume as the yellow (Y) ink or cyan (C) ink). Likewise, a color tone produced by discharging, among the three primary color inks, the magenta (M) and cyan (C) inks with the proportion of 1:1 is identical to a color tone expressed by a blue color (hereinafter, symbol (B)) ink, comparable to the medium color tone, discharged in volume 1 (same volume as the magenta (M) ink or cyan (C) ink).

The ink recording head according to the present disclosure includes, in addition to the recording heads configured to record the inks of the three primary colors; yellow (Y), magenta (M), and cyan (C), the recording heads configured to record the inks of red (R), green (G), and blue (B) comparable to the medium color tones. Another example for comparison is given here; an ink recording head solely consisting of the recording heads configured to record the inks of yellow (Y), magenta (M), and cyan (C), with none of the recording heads configured to record the inks of red (R), green (G), and blue (B). Comparing these ink recording heads, color tones expressed through the compared example by secondary colors ((i) yellow (Y) and magenta (M), (ii) yellow (Y) and cyan (C), (iii) cyan (C) and magenta (M)) may be each expressed through the ink recording head disclosed herein by a single color ink (red (R), green (G), blue (B)). Furthermore, the total ink volume discharged from the ink recording head disclosed herein may be reduced to a half (50%) of that of the compared example.

The ink recording head according to the present disclosure may decrease the inks to be discharged in total, effectively suppressing the occurrence of color smearing.

This ink recording head thus achieving reduction of the total ink volume may conduce to shorter drying time. This may also be a contributing factor that suppresses the occurrence of color smearing.

Further advantageously, the ink recording head according to the present disclosure conducing to shorter drying time may allow the printing to be performed at higher speeds.

Yet another advantage of the ink recording head according to the present disclosure is reduction of running costs achievable by the ability to produce desired color tones with smaller volumes of inks than required by the ink recording head of the compared example.

The medium color tone of two colors described herein may not necessarily be a color tone produced by mixing two color inks in an equal volume. The proportions of inks to be mixed then may be optionally decidable.

The printing apparatus according to the present disclosure may be further characterized in that the ink recording head 10 includes a recording head 10 (K) configured to record a black (K) ink, wherein

the controller prompts the ink recording head 10 to use the black (K) ink when a color tone is produced by mixing the three primary colors in an equal volume.

This may achieve further reduction of the total ink volume discharged from the ink recording head.

This advantageous effect may be attained because a color tone produced by discharging the three primary color inks; the yellow (Y), magenta (M), and cyan (C) inks, with the proportion of 1:1:1 is identical to a color tone expressed by the black (K) ink, comparable to the medium color tone, discharged in volume 1 (same volume as the yellow (Y), magenta (M), or cyan (C) ink).

As compared to the ink recording head for comparison solely consisting of the recording heads configured to record the inks of yellow (Y), magenta (M), and cyan (C), a color tone expressed through this ink recording head by a tertiary color (of yellow (Y), magenta (M), and cyan (C)) may be expressed through the ink recording head according to the present disclosure by a single color ink (black (K)). Furthermore, the total ink volume discharged from the ink recording head disclosed herein may be reduced to one-third (approximately 33%) of that of the compared example.

Thus, the total ink volume may further decrease, more effectively suppressing the occurrence of color smearing.

This ink recording head thus achieving further reduction of the total ink volume may conduce to even shorter drying time. This may also be a contributing factor that suppresses the occurrence of color smearing.

Further advantageously, the ink recording head disclosed herein conducing to even shorter drying time may allow the printing to be performed at further higher speeds.

The ink recording head disclosed herein may also contribute to further reduction of running costs.

The printing apparatus according to the present disclosure may be further characterized in that the ink recording head 10 includes recording heads configured to record inks of yellow (Y), magenta (M), cyan (C), red (R), green (G), blue (B), and black (K). The printing apparatus thus characterized may successfully exert the advantageous effects described so far.

The printing apparatus according to the present disclosure may be further characterized in that the ink recording head includes recording heads configured to record inks of lighter colors of yellow (Y), magenta (M), and cyan (C) (LY (light yellow), LM (light magenta), LC (light cyan)) and recording heads configured to record inks of lighter colors of red (R), green (G), blue (B), and black (K) (LR (light red), LG (light green), LB (light blue), LK (light black)). The printing apparatus thus characterized may successfully exert the advantageous effects described so far.

The printing apparatus according to the present disclosure may be further characterized in that the control device, based on information pertinent to discharge volumes of the inks of yellow (Y), magenta (M), cyan (C), red (R), green (G), blue (B), and black (K) required to produce a predetermined color tone, prompts the ink recording head 10 to discharge the inks of the respective colors. The printing apparatus thus characterized may successfully exert the advantageous effects described so far.

The printing apparatus according to the present disclosure may be further characterized in that the control device obtains information pertinent to inks of the respective colors required to produce a predetermined color tone, the control device prompts the ink recording head 10 to discharge, in place of the inks of yellow (Y) and magenta (M), the ink of red (R) comparable to a medium color tone produced by mixing the inks of yellow (Y) and magenta (M) when the information obtained includes information indicating discharge of the inks of yellow (Y) and magenta (M), the control device prompts the ink recording head 10 to discharge, in place of the inks of yellow (Y) and cyan (C), the ink of green (G) comparable to a medium color tone produced by mixing the inks of yellow (Y) and cyan (C) when the information obtained includes information indicating discharge of the inks of yellow (Y) and cyan (C), and the control device prompts the ink recording head 10 to discharge, in place of the inks of cyan (C) and magenta (M), the ink of blue (B) comparable to a medium color tone produced by mixing the inks of cyan (C) and magenta (M) when the information obtained includes information indicating discharge of the inks of cyan (C) and magenta (M).

The printing apparatus according to the present disclosure may be further characterized in that the control device controls the ink recording head 10 so that a color tone produced by discharging the inks of yellow (Y) and magenta (M) with the proportion of 1:1 in a predetermined total volume (a) per unit area of a recording target surface is expressed by the ink of red (R) discharged in one-half of the predetermined volume (a) per unit area.

This may be rephrased as below. The ink recording head 10 is controlled so that the color tone produced by discharging the inks of yellow (Y) and magenta (M) on the recording target surface with the proportion of 1:1 until the amount in total of the discharged inks per unit area of the recording target surface reaches the predetermined volume (a) may be expressed by setting the amount in total of the ink of red (R) discharged on the recording symmetry surface per unit area to one-half of the predetermined volume (a).

The printing apparatus according to the present disclosure may be further characterized in that the control device controls the ink recording head 10 so that a color tone produced by discharging the inks of yellow (Y) and cyan (C) on the recording target surface with the proportion of 1:1 until the amount in total of the discharged inks per unit area of the recording target surface reaches a predetermined volume (b) may be expressed by setting the amount in total of the ink of green (G) discharged on the recording target surface per unit area to one-half of the predetermined volume (b).

The printing apparatus according to the present disclosure may be further characterized in that the control device controls the ink recording head 10 so that a color tone produced by discharging the inks of magenta (M) and cyan (C) on the recording target surface with the proportion of 1:1 until the amount in total of the discharged inks per unit area of the recording target surface reaches a predetermined volume (c) may be expressed by setting the amount in total of the ink of blue (B) discharged on the recording target surface per unit area to one-half of the predetermined volume (c).

The printing apparatus according to the present disclosure may be further characterized in that the control device controls the ink recording head 10 so that a color tone produced by discharging the inks of yellow (Y), magenta (M), and cyan (C) on the recording target surface with the proportion of 1:1:1 until the amount in total of the discharged inks per unit area of the recording target surface reaches a predetermined volume (d) may be expressed by setting the amount in total of the ink of black (K) discharged on the recording target surface per unit area to one-third of the predetermined volume (d).

To achieve the same end, a printing method according to the present disclosure is a printing method of using a printing apparatus equipped with an ink recording head and operable to print an optional color by way of color separation into three primary colors, wherein when producing a medium color tone by mixing inks of two colors among the three primary colors, a single color ink that exhibits the medium color tone of the two colors is used.

This printing method may exert the same advantageous effects as the printing apparatus.

### Advantageous Effect of Invention

The present disclosure provides a printing apparatus and a printing method that may suppress the occurrence of color smearing.

### BRIEF DESCRIPTION OF DRAWINGS

FIG. 1 is a perspective view of an ink discharge head employed in a printing apparatus according to an embodiment of the present disclosure.

FIG. 2 is a sectional view of a multilayered body formed from different color inks discharged from the ink discharge head illustrated in FIG. 1.

FIG. 3 is schematic drawing provided to illustrate effects of the ink discharge head according to the embodiment of the present disclosure, wherein FIG. 3 (a) illustrates an example for comparison, and FIG. 3 (b) illustrates ink volumes used in the ink discharge head according to the embodiment of the present disclosure.

FIG. 4 is schematic drawing provided to illustrate effects of the ink discharge head according to the embodiment of the present disclosure, wherein FIG. 4 (a) illustrates an example for comparison, and FIG. 4 (b) illustrates ink volumes used in the ink discharge head according to the embodiment of the present disclosure.

FIG. 5 is schematic drawing provided to illustrate effects of the ink discharge head according to the embodiment of the present disclosure, wherein FIG. 5 (a) illustrates an example for comparison, and FIG. 5 (b) illustrates ink volumes used in the ink discharge head according to the embodiment of the present disclosure.

### DESCRIPTION OF EMBODIMENT

An embodiment of a printing apparatus and a printing method according to the present disclosure is described in detail referring to the accompanying drawings.

(1) Ink Recording Head of Printing Apparatus According to the Embodiment

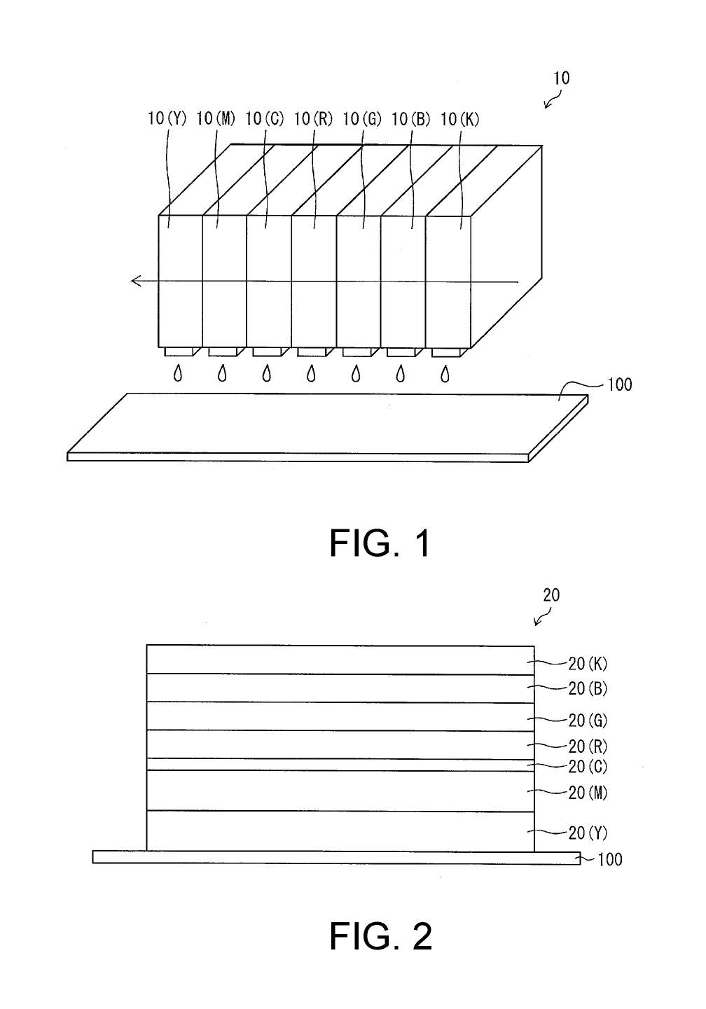

FIG. 1 is a perspective view of an ink recording head according to the embodiment. An ink recording head 10 according to the embodiment has a recording head 10 (Y) that records a yellow (Y) ink, a recording head 10 (M) that records a magenta (M) ink, a recording head 10 (C) that records a cyan (C) ink, a recording head 10 (R) that records a red (R) ink, a recording head 10 (G) that records a green (G) ink, a recording head 10 (B) that records a blue (B) ink, and a recording head 10 (K) that records a black (K) ink.

The recording heads 10 (Y), 10 (M), 10 (C), 10 (R), 10 (G), 10 (B), and 10 (K) are aligned in a row in the mentioned order. These recording heads each have a nozzle hole on a side of the recording head facing a recording target 100. These recording heads constitute a mechanism prompted by a control device (controller), not illustrated in the drawing, to discharge a predetermined volume of ink through each nozzle hole.

Each recording head is filled with an ink as a coloring material. Of these recording heads, the recording head 10 (K) is filled with the black (K) ink. A color tone produced by discharging the yellow (Y), magenta (M), and cyan (C) inks with the proportion of 1:1:1 in a predetermined total volume (d) per unit area of a recording target surface is expressed by this black (K) ink discharged in one-third of the predetermined volume (d) per unit area.

This may be rephrased as below. The color tone produced by discharging the yellow (Y), magenta (M), and cyan (C) inks on the recording target surface with the proportion of 1:1:1 until the amount in total of the discharged inks per unit area of the recording target surface reaches the predetermined volume (d) is expressible by setting the amount in total of this black (K) ink discharged on the recording target surface per unit area to one-third of the predetermined volume (d).

The recording head 10 (R) is filled with the red (R) ink. A color tone produced by discharging the yellow (Y) and magenta (M) inks with the proportion of 1:1 in a predetermined total volume (a) per unit area of the recording target surface is expressible by this red (R) ink discharged in one-half of the predetermined volume (a) per unit area.

The recording head 10 (G) is filled with the green (G) ink. A color tone produced by discharging the yellow (Y) and cyan (C) inks with the proportion of 1:1 in a predetermined total volume (b) per unit area of the recording target surface is expressible by this green (G) ink discharged in one-half of the predetermined volume (b) per unit area.

The recording head 10 (B) is filled with the blue (B) ink. A color tone produced by discharging the cyan (C) and magenta (M) inks with the proportion of 1:1 in a predetermined total volume (c) per unit area of the recording target surface is expressible by this blue (B) ink discharged in one-half of the predetermined volume (c) per unit area.

(2) Structural and Technical Features of the Printing Apparatus

The printing apparatus according to this embodiment has the ink recording head 10 illustrated in FIG. 1.

The printing apparatus according to this embodiment further has a position change mechanism (not illustrated in the drawing) configured to move the ink recording head 10 to change relative positions of the ink recording head 10 and the recording target 100. The position change mechanism can move the ink recording head 10 in a direction indicated with an arrow in FIG. 1. As the ink recording head 10 having the recording heads 10 (Y), 10 (M), 10 (C), 10 (R), 10 (G), 10 (B), and 10 (K) arranged in this order moves in the arrow direction, the recording heads 10 (Y), 10 (M), 10 (C), 10 (R), 10 (G), 10 (B), and 10 (K), in the arranged order, pass over a certain region on the upper surface of the recording target 100. By discharging the inks from these recording heads, a multilayered body 20 made up of different color ink layers is formed in the certain region on the upper surface of the recording target 100, as illustrated in FIG. 2. The ink layers constituting the multilayered body 20 are specifically, an ink layer 20 (Y) formed on the upper surface of the recording target 100 from the yellow (Y) ink discharged from the recording head 10 (Y), an ink layer 20 (M) formed on the ink layer 20 (Y) from the magenta (M) ink discharged from the recording head 10 (M), an ink layer 20 (C) formed on the ink layer 20 (M) from the cyan (C) ink discharged from the recording head 10 (C), an ink layer 20 (R) formed on the ink layer 20 (C) from the red (R) ink discharged from the recording head 10 (R), an ink layer 20 (G) forming on the ink layer 20 (R) from the green (G) ink discharged from the recording head 10 (G), an ink layer 20 (B) formed on the ink layer 20 (G) from the blue (B) ink discharged from the recording head 10 (B), and an ink layer 20 (K) formed on the ink layer 20 (B) from the black (K) ink discharged from the recording head 10 (K).

For the purpose of illustration, the multilayered body illustrated in FIG. 2 is formed from the inks discharged from all of the recording heads. However, the practical operation forms any ones of these ink layers that are only necessary for producing a desired color tone. In other words, it is determined beforehand which ones of the recording heads are assigned to ink discharge for a color tone desirably obtained. By discharging the inks from the assigned recording heads, the ink layers are stacked on one another (or a single ink layer), and the resulting multilayered body exhibits the desired color tone.

(3) Technical Problem

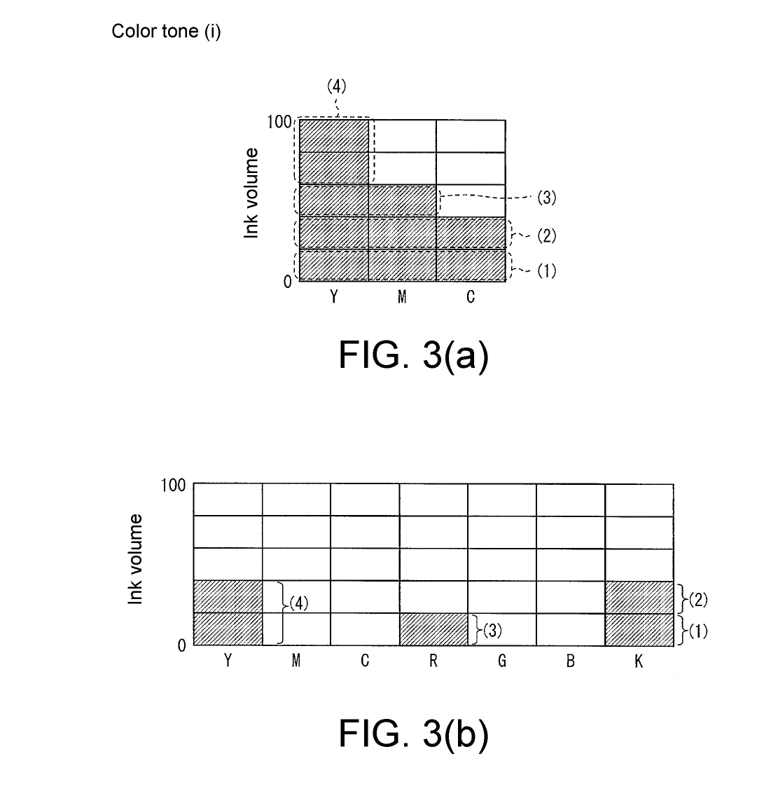

As well-known to those skilled in the art, desired color tones are producible by differently mixing three color inks of yellow (Y), magenta (M), and cyan (C) and/or varying proportions of these color inks to be mixed. However, the inventors of the present application focused on the fact that using three color inks of yellow (Y), magenta (M), and cyan (C), or four color inks further including a black (K) ink often resulted in color smearing, failing to perform high-resolution printing in desired color tones. The inventors continued to seek solutions to this problem and arrived at the conclusion that an abundance of inks was a probable cause ink of smearing. This is hereinafter described referring to FIG. 3.

FIG. 3(a) is a schematic drawing of ink volumes required to produce a certain color tone by an ink discharge head for comparison that uses the yellow (Y), magenta (M), and cyan (C) inks alone for printing. Each cell illustrated in FIG. 3(a) shows the ink volume per unit area of 20. The ink volume of “100” illustrated in FIG. 3 represents a maximum ink volume (upper-limit discharge volume) per unit area dischargeable at a time from one recording head. All of the color ink recording heads have the capacity of ink discharge of 100 at most per unit area. These recording heads are configured to change their discharge volumes up to 100 to produce a desired color tone.

The ink discharge head for comparison illustrated in FIG. 3(a), in order to produce the certain color tone, needs to discharge the yellow (Y) ink in the volume of 100, the magenta (M) ink in the volume of 60, and the cyan (C) ink in the volume of 40. The inks are discharged in layers as illustrated in FIG. 2, and the resulting multilayered body exhibits the certain color tone. That is, the ink discharge head for comparison illustrated in FIG. 3(a) results in the total ink volume of 200 (100+60+40) to produce the certain color tone. This attracted the inventors' attention, posing the question that such an abundance of inks may be a probable cause of color smearing. The inventors studied and searched for ways to reduce the total ink consumption, and finally formulated technical aspects presented in this embodiment.

FIG. 3(b) is a schematic drawing of volumes of inks necessary for producing a certain color tone using the ink discharge head according to this embodiment. This drawing illustrates the inks used and their volumes to produce the same color tone as illustrated in FIG. 3(a). To come right to the point, the inventors' finding is that the same color tone as produced through the ink discharge head for comparison illustrated in FIG. 3(a) from the total ink volume of 200 may be produced through the ink discharge head according to this embodiment from the total ink volume of 100 as illustrated in FIG. 3(b) (summed volume of yellow (Y) ink=40, red (R) ink=20, and black (K) ink=40). This finding is described in detail by way of a printing method according to this embodiment.

(4) Control Device of Printing Apparatus According to the Embodiment

The printing apparatus according to this embodiment includes a control device (controller) configured to control the ink recording head 10 illustrated in FIG. 1. The control device is essentially configured to control the ink recording head in a manner described below; a color tone produced by discharging the yellow (Y), magenta (M), and cyan (C) inks is expressed by the black (K) ink discharged instead of these color inks, a color tone produced by discharging the yellow (Y) and magenta (M) inks is expressed by the red (R) ink discharged instead of these color inks, a color tone produced by discharging the yellow (Y) and cyan (C) inks is expressed by the green (G) ink discharged instead of these color inks, and a color tone produced by discharging the cyan (C) and magenta (M) inks is expressed by the blue (B) ink discharged instead of these color inks.

As illustrated in FIG. 1, the ink recording head 10 of the printing apparatus according to this embodiment has, in addition to the recording heads 10 (Y), 10 (M), and 10 (C), recording heads 10 (K), 10 (R), 10 (G), and 10 (B), and the control device controls all of these recording heads. This printing apparatus thus characterized may exert the advantageous effects described earlier.

More specifically, in this embodiment, a portion of the yellow (Y), magenta (M), and cyan (C) inks discharged from the ink recording head for comparison with the proportion of 1:1:1 is replaced with the black (K) ink. The ink recording head 10 according to this embodiment (FIG. 1) has the recording head 10 (K) filled with the black (K) ink, wherein the color tone produced by discharging the yellow (Y), magenta (M), and cyan (C) inks with the proportion of 1:1:1 in the predetermined total volume (d) per unit area of the recording target surface is expressed by this black (K) ink discharged in one-third of the predetermined volume (d) per unit area. This embodiment may, not only decrease color numbers by allowing the black (K) alone to express a tertiary color of the yellow (Y), magenta (M), and cyan (C), but also decrease the discharged ink volume per unit area necessary for color tone expression to one-third of the total volume of the yellow (Y), magenta (M), and cyan (C) inks discharged for the same purpose.

In this embodiment, a portion of the yellow (Y) and magenta (M) inks discharged from the ink recording head for comparison with the proportion of 1:1 is replaced with the red (R) ink. The ink recording head 10 according to this embodiment (FIG. 1) has the recording head 10 (R) filled with the red (R) ink, wherein the color tone produced by discharging the yellow (Y) and magenta (M) inks with the proportion of 1:1 in the predetermined total volume (a) per unit area of the recording target surface is expressed by this red (R) ink discharged in one-half of the predetermined volume (a) per unit area. This embodiment may, not only decrease color numbers by allowing the red (R) alone to express a secondary color of the yellow (Y) and magenta (M), but also decrease the discharged ink volume per unit area necessary for color tone expression to one-half of the total volume of yellow (Y) and magenta (M) inks discharged for the same purpose.

In this embodiment, a portion of the yellow (Y) and cyan (C) inks discharged from the ink recording head for comparison with the proportion of 1:1 is replaced with the green (G) ink. The ink recording head 10 according to this embodiment (FIG. 1) has the recording head 10 (G) filled with the green (G) ink, wherein the color tone produced by discharging the yellow (Y) and cyan (C) inks with the proportion of 1:1 in the predetermined total volume (b) per unit area of the recording target surface is expressed by this green (G) ink discharged in one-half of the predetermined volume (b) per unit area. This embodiment may, not only decrease color numbers by allowing the green (G) alone to express a secondary color of the yellow (Y) and cyan (C), but also decrease the discharged ink volume per unit area necessary for color tone expression to one-half of the total volume of yellow (Y) and cyan (C) inks discharged for the same purpose.

In this embodiment, a portion of the cyan (C) and magenta (M) inks discharged from the ink recording head for comparison with the proportion of 1:1 is replaced with the blue (B) ink. The ink recording head 10 according to this embodiment (FIG. 1) has the recording head 10 (B) filled with the blue (B) ink, wherein the color tone produced by discharging the cyan (C) and magenta (M) inks with the proportion of 1:1 in the predetermined total volume (b) per unit area of the recording target surface is expressed by this blue (B) ink discharged in one-half of the predetermined volume (c) per unit area. This embodiment may, not only decrease color numbers by allowing the blue (B) alone to express a secondary color of the cyan (C) and magenta (M), but also decrease the discharged ink volume per unit area necessary for color tone expression to one-half of the total volume of cyan (C) and magenta (M) discharged for the same purpose.

The advantageous effects of this embodiment are hereinafter described in further detail by way of some specific color tones.

Color Tone (i)

The effects are described referring to the color tone illustrated in FIG. 3. FIG. 3(a) and FIG. 3(b) are schematic drawings of colors and their discharge volumes used to produce the same color tone (i).

Referring to FIG. 3(a), cells (1) indicate a portion of the yellow (Y), magenta (M), and cyan (C) inks discharged with the proportion of 1:1:1 from the ink recording head for comparison. The ink volume of this portion is 60 in total (total ink volume); the yellow (Y), magenta (M), and cyan (C) inks each in the volume of 20.

Referring to FIG. 3(b) illustrating the effect of the printing apparatus according to this embodiment, the same portion corresponds to a cell (1) illustrated in FIG. 3(b). The cell (1) in FIG. 3(b) is a portion of the black (K) ink alone in the volume of 20. According to this embodiment, the color tone of the cell (1) may be expressed by one-third (approximately 33%) of the ink volume of the ink recording head for comparison.

According to this embodiment, the color tone of a cell (2) may also be expressed by one-third (approximately 33%) of the ink volume of the ink recording head for comparison.

Referring to FIG. 3(a) again, cells (3) indicate a portion of the yellow (Y) and magenta (M) inks discharged with the proportion of 1:1 from the ink recording head for comparison. The ink volume of this portion is 40 in total (total ink volume); the yellow (Y) and magenta (M) inks each in the volume of 20. Referring to FIG. 3(b) illustrating the effect of the ink recording head according to this embodiment, the same portion corresponds to a cell (3) illustrated in FIG. 3(b). The cell (3) in FIG. 3(b) is a portion of the red (R) ink alone in the volume of 20. In this embodiment, the color tone of the cell (3) may be expressed by one-half (50%) of the ink volume of the ink recording head for comparison.

In this embodiment, when any colors but the yellow (Y), magenta (M), or cyan (C) are desirably expressed by tertiary colors of the yellow (Y), magenta (M), and cyan (C), all of replaceable portions should be replaced as described above. Thus, combinations of the yellow (Y) and other colors of the cells (1), (2), and (3) illustrated in FIG. 3(a) are replaced with different colors. On the other hand, cells (4) in FIG. 3(a) are both expressed by the yellow (Y) ink alone. Therefore, also in this embodiment, these cells (4) are likewise solely expressed by the yellow (Y) ink, and its discharge volume is 40 as with the ink recording head for comparison.

Expressing the color tone (i) according to this embodiment may decrease the total ink volume as compared to printing methods using the ink recording head for comparison. Specifically, the total ink volume of 200 (summed volume of yellow (Y) ink=100, magenta (M)=60, cyan (C)=40) of the compared example may be decreased to the total ink volume of 100 (summed volume of yellow (Y) ink=40, red (R) ink=20, black (K) ink=40).

This embodiment may thus decrease the total ink volume used to produce the color tone (i) as compared to tertiary color printing methods (printing methods using the ink recording head for comparison).

Color Tone (ii)

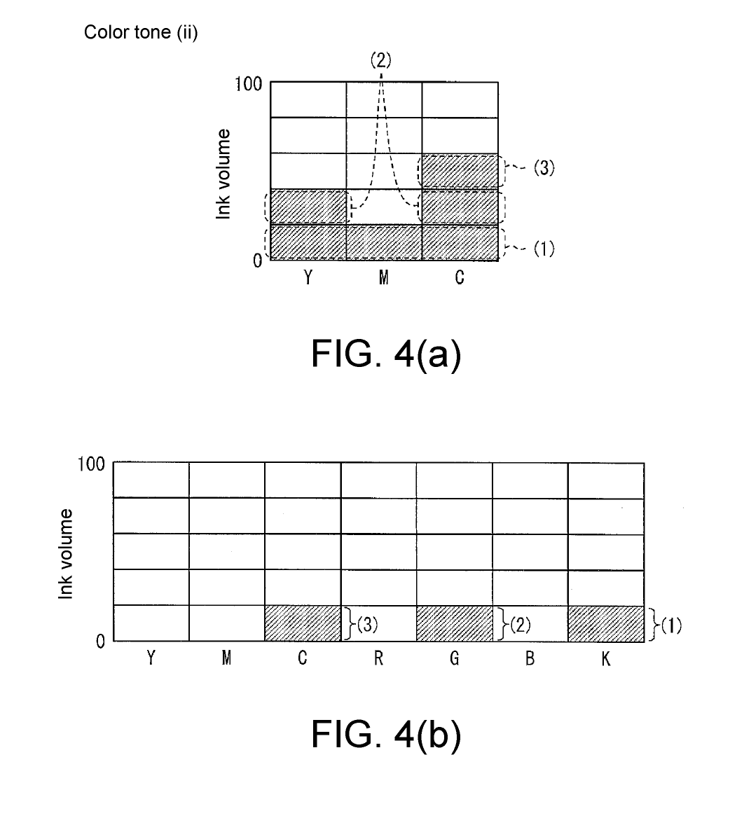

FIG. 4(a) and FIG. 4(b) show inks and their discharge volumes used to produce the same color tone (ii). FIG. 4(a) illustrates the result of the printing method using the ink recording head for comparison. FIG. 4(b) illustrates the result of the printing method using the ink recording head according to this embodiment.

Referring to FIG. 4(a), cells (1) indicate a portion of the yellow (Y), magenta (M), and cyan (C) inks discharged with the proportion of 1:1:1 from the ink recording head for comparison. The ink volume of this portion is 60 in total (total ink volume); the yellow (Y), magenta (M), and cyan (C) inks each in the volume of 20.

Referring to FIG. 4(b) illustrating the effect of this embodiment, the same portion corresponds to a cell (1) illustrated in FIG. 4(b). The cell (1) in FIG. 4(b) is a portion of the black (K) ink alone in the volume of 20. According to this embodiment, the color tone of the cell (1) may be expressed by one-third (approximately 33%) of the ink volume of the ink recording head for comparison.

Referring to FIG. 4(a) again, cells (2) indicate a portion of the yellow (Y) and cyan (C) inks discharged with the proportion of 1:1 from the ink recording head for comparison. The ink volume of this portion is 40 in total (total ink volume); the yellow (Y) and cyan (C) inks each in the volume of 20. Referring to FIG. 4(b) illustrating the effect of this embodiment, the same portion corresponds to a cell (2) illustrated in FIG. 4(b). The cell (2) in FIG. 4(b) is a portion of the green (R) ink alone in the volume of 20. In this embodiment, the color tone of the cell (2) may be expressed by one-half (50%) of the ink volume of the ink recording head for comparison.

Any single color not included in combinations with the other colors, like cyan (C) of a cell (3) illustrated in FIG. 4(a), is handled likewise in this embodiment. This cell is, therefore, a portion of cyan (C) ink alone, and its discharge volume is 20 as with the ink recording head for comparison.

Expressing the color tone (ii) according to this embodiment may decrease the total ink volume as compared to printing methods using the ink recording head for comparison. Specifically, the total ink volume of 120 (summed volume of yellow (Y) ink=40, magenta (M)=20, cyan (C)=60) of the compared example may be decreased to the total ink volume of 60 (summed volume of cyan (C) ink=20, green (G) ink=20, black (K) ink=20).

This embodiment may thus decrease the total ink volume used to produce the color tone (ii) as compared to tertiary color printing methods (printing methods using the ink recording head for comparison).

Color Tone (iii)

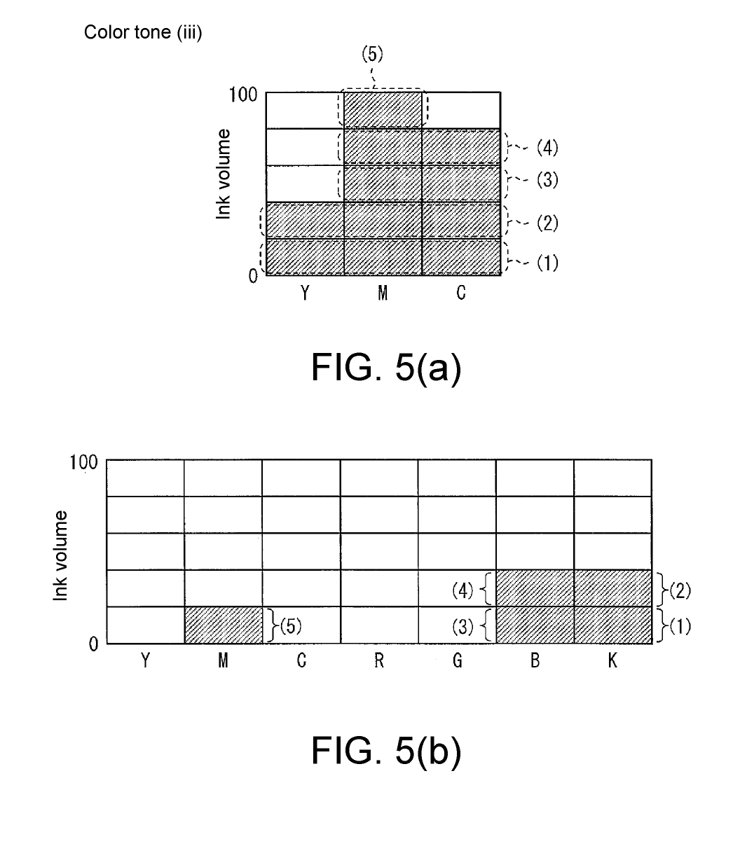

FIG. 5(a) and FIG. 5(b) show inks and their volumes used to produce the same color tone (iii). FIG. 5(a) illustrates the result of the printing method using the ink recording head for comparison. FIG. 5(b) illustrates the result of the printing method using the ink recording head according to this embodiment.

Referring to FIG. 5(a), cells (1) indicate a portion of the yellow (Y), magenta (M), and cyan (C) inks discharged with the proportion of 1:1:1 from the ink recording head for comparison. The ink volume of this portion is 60 in total (total ink volume); the yellow (Y), magenta (M), and cyan (C) inks each in the volume of 20.

Referring to FIG. 5(b) illustrating the effect of this embodiment, the same portion corresponds to a cell (1) illustrated in FIG. 5(b). The cell (1) in FIG. 5(b) is a portion of the black (K) ink alone in the volume of 20. According to this embodiment, the color tone of the cell (1) may be expressed by one-third (approximately 33%) of the ink volume of the ink recording head for comparison.

According to this embodiment, the color tone of a cell (2) may also be expressed by one-third (approximately 33%) of the ink volume of the ink recording head for comparison.

Referring to FIG. 5(a) again, cells (3) indicate a portion of the magenta (M) and cyan (C) inks discharged with the proportion of 1:1 from the ink recording head for comparison. The ink volume of this portion is 40 in total (total ink volume); the magenta (M) and cyan (C) inks each in the volume of 20. Referring to FIG. 5(b) illustrating the effect of this embodiment, the same portion corresponds to a cell (3) illustrated in FIG. 5(b). The cell (3) in FIG. 5(b) is a portion of the blue (B) ink alone in the volume of 20. In this embodiment, the color tone of the cell (3) may be expressed by one-half (50%) of the ink volume of the ink recording head for comparison.

According to this embodiment, the color tone of a cell (4) may also be expressed by one-half (50%) of the whole ink volume of the ink recording head for comparison.

Any single color not included in combinations with the other colors, like magenta (M) of a cell (5) illustrated in FIG. 5(a), is handled likewise in this embodiment. This cell is, therefore, a portion of magenta (M) ink alone, and its discharge volume is 20 as with the ink recording head for comparison.

Expressing the color tone (iii) according to this embodiment may decrease the total ink volume as compared to printing methods using the ink recording head for comparison. Specifically, the total ink volume of 220 (summed volume of yellow (Y) ink=40, magenta (M)=100, cyan (C)=80) of the compared example may be decreased to the total ink volume of 100 (summed volume of cyan (C) ink=20, blue (B) ink=40, black (K) ink=40).

This embodiment may thus decrease the total ink volume used to produce the color tone (iii) as compared to tertiary color printing methods (printing methods using the ink recording head for comparison).

The Y, M, C, R, G, B, and K color data reflective of the previously described printing method according to this embodiment is input to the control device of the printing apparatus according to this embodiment. The control device controls the respective recording heads based on the input data.

As described thus far, this embodiment may decrease the total ink volume, thereby enabling a color smearing-suppressed printing performance. The printing method according to this embodiment may decrease the used ink volumes to 40% to 60% on average in typical natural images, as compared to Y, M, and C tertiary color printing methods (printing methods using the ink recording head for comparison).

This ink recording head thus achieving reduction of the total ink volume may conduce to shorter drying time. This may also be a contributing factor that suppresses the occurrence of color smearing. The ink recording head conducing to shorter drying time may accelerate printing speeds. The ink recording head thus advantageous may be suitable for high-speed printers. The ink recording head may be capable of producing desired color tones with smaller volumes of inks than the ink recording head for comparison, contributing to reduction of running costs. As in inks for textiles (Tx inks), for example, using an abundant volume of inks may provoke the occurrence of color smearing due to factors apart from overly long drying time. This embodiment may provide an effective anti-smearing solution for such inks.

### First Modified Example

In the example described in this embodiment referring to, for instance, FIG. 3, the used inks are replaced with the black (K) or red (R) ink in accordance with Y, M, and C tertiary color combinations illustrated in FIG. 3(a). This is, however, a non-limiting example of the present disclosure.

Taking the Y, M, and C tertiary color combinations illustrated in FIG. 3(a) for instance, the portion of the yellow (Y) and magenta (M) inks mixed with the proportion of 1:1 (total ink volume of 120 (=20×6)) may be replaced with the red (R) ink, and the portion of the yellow (Y) and cyan (C) inks mixed with the proportion of 1:1 (total ink volume of 80 (=20×4)) may be replaced with the green (G) ink.

In this instance, the total ink volume after the replacement is the sum (=100) of the red (R) ink volume of 60 and the green (G) ink volume of 40. Thus, the resulting total ink volume may be reduced to one-half of the total ink volume of 200 before the replacement.

As per this instance, the replacement of inks should particularly not be limited. Thus replacing the inks differently does not affect color tones to be ultimately produced. Also for the other color tones as illustrated in FIG. 4 and FIG. 5, how the inks should be replaced may be optionally decidable.

To lessen the total ink volume, more inks may preferably be replaced with the black (K) ink that achieves a higher rate of reduction.

### Second Modified Example

In the embodiment described so far, the Y, M, C, R, G, B, and K color data is input to the control device of the printing apparatus. This is, however, a non-limiting example of the present disclosure. Alternatively, the Y, M, and C tertiary color data (information) may be input to the control device, and the control device is in charge of replacing the inks as described referring to FIG. 3 to FIG. 5.

A printing method according to a modified example is hereinafter described, wherein the Y, M, and C tertiary color data is input to the control device.

It is not particularly limited how the color inks should be replaced as described earlier. For replacement, however, the priority is placed on the black (K) ink over any other color inks on account of more effective reduction of the total ink volume.

The control device, based on the data (information) externally input thereto, identifies one of the Y, M, and C color inks smallest in volume (p tentatively refers to the smallest volume), and performs triple color replacement in which the Y, M, and C color inks in the volume p are replaced with the black (K) ink. In case where the data externally input to the control device does not contain data of the Y, M, or C color ink, indicating that the color ink missing in the data should not be discharged, or that the ink discharge should be performed in one of combinations (Y and M), (Y and C), and (C and M), double color replacement is performed in place of the triple color replacement.

The control device, of the remaining two color inks subsequent to the triple color replacement (since the volume of one of Y, M, and C already replaced with black is zero), identifies again one of the two colors smaller than the other (q tentatively refers to the smaller volume), and performs double color replacement in which the remaining two color inks in the volume q are replaced with the R, G, or B ink. In case where the triple color replacement leaves only one of the Y, M, and C color inks, the double color replacement is not performed.

Once the triple color replacement and the double color replacement are both successfully done, the (Y, M, C) data input to the control device is replaced with data {(one of Y, M, C=0), (one of R, G, B=0, K}. Then, the total ink volume may be decreased.

Also in case where the double color replacement alone is performed, without the triple color replacement, the (Y, M, C) data input to the control device is replaced with data {(one of Y, M, C), (one of R, G, B)}. Then, the total ink volume may eventually be decreased.

According to the second modified example, the Y, M, and C tertiary color data is input to the control device. Alternatively, the Y, M, C, R, G, B, and K color data may be input to the control device, and the Y, M, C data may be extracted from the input data to perform at least one of the triple color replacement and the double color replacement.

### Third Modified Example

In the embodiment described so far, the ink recording head of the printing apparatus includes the Y, M, C, R, G, B, and K recording heads. This is, however, a non-limiting example of the present disclosure. In addition to or in place of these recording heads, the ink recording head may include recording heads that record inks of lighter color (LY) of yellow (Y), lighter color (LM) of magenta (M), lighter color (LC) of cyan (C), lighter color (LR) of red (R), lighter color (LG) of green (G), lighter color (LB) of blue (B), and lighter color (LB) of black (K).

In the third modified example of the ink recording head including the recording heads that record the lighter colors, the control device controls the ink recording head so that a color tone produced by discharging the inks of yellow (Y) lighter color (LY) and magenta (M) lighter color (LM) with the proportion of 1:1 in a predetermined total volume (a′) per unit area of the recording target surface is expressed by the ink of red (R) lighter color (LR) discharged in one-half of the predetermined volume (a′) per unit area.

In the third modified example, the control device further controls the ink recording head 10 so that a color tone produced by discharging the inks of yellow (Y) lighter color (LY) and cyan (C) lighter color (LC) with the proportion of 1:1 in a predetermined total volume (b′) per unit area of the recording target surface is expressed by the ink of green (G) lighter color (LG) discharged in one-half of the predetermined volume (b′) per unit area.

In the third modified example, the control device further controls the ink recording head 10 so that a color tone produced by discharging the inks of cyan (C) lighter color (LC) and magenta (M) lighter color (LM) with the proportion of 1:1 in a predetermined total volume (c′) per unit area of the recording target surface is expressed by the ink of blue (B) lighter color (LB) discharged in one-half of the predetermined volume (c′) per unit area.

In the third modified example, the control device further controls the ink recording head 10 so that a color tone produced by discharging the inks of yellow (Y) lighter color (LY) ink, magenta (M) lighter color (LM), and cyan (C) lighter color (LC) with the proportion of 1:1:1 in a predetermined total volume (d′) per unit area of the recording target surface is expressed by the ink of black (K) lighter color (LK) discharged in one-third of the predetermined volume (d′) per unit area.

This third modified example may effectively cut down on the discharged ink volumes, as described in the earlier embodiment using the (L, M, C, R, G, B, and K) color inks.

The printing apparatus according to an embodiment of the present disclosure includes the ink recording head 10 and the control device configured to control the ink recording head 10. The printing apparatus is operable to print an optional color by way of color separation into three primary colors. When a medium color tone is produced by mixing inks of two colors among the three primary colors (for example, yellow (Y), magenta (M), and cyan (C)), the controller prompts the ink recording head 10 to use a single color ink (for example, red (R), green (G), or blue (B)) that exhibits the medium color tone of the two colors. The ink recording head 10 includes ink recording heads 10 (Y), 10 (M), and 10 (C) configured to record inks of the three primary colors (for example, yellow (Y), magenta (M), cyan (C)), and further includes recording heads 10 (R), 10 (G), and 10 (B) configured to record inks (for example, red (R), green (G), and blue (B)) that exhibit medium color tones produced by mixing inks of two colors among the three primary colors.

According to the above configuration, the ink recording head 10 includes ink recording heads 10 (Y), 10 (M), and 10 (C) configured to record the yellow (Y), magenta (M), and cyan (C) color inks, and further includes recording heads 10 (R), 10 (G), and 10 (B) configured to record the red (R), green (G), and blue (B) inks. As compared the ink recording head for comparison not equipped with recording heads 10 (R), 10 (G), and 10 (B) configured to record the red (R), green (G), and blue (B) inks, the ink recording head 10 may successfully cut down on the total ink volume required to produce a desired color tone, thereby suppressing the occurrence of color smearing.

This advantageous effect may be attained because the color tone produced by discharging the yellow (Y) and magenta (M) inks with the proportion of 1:1 is identical to the color tone expressed by the red (R) color ink discharged in volume 1 (same volume as the yellow (Y) ink, or magenta (M) ink). Similarly, the color tone produced by discharging the yellow (Y) and cyan (C) inks with the proportion of 1:1 is identical to the color tone expressed by the green (G) ink discharged in volume 1 (same volume as the yellow (Y) ink, or cyan (C) ink). Similarly, the color tone produced by discharging the magenta (M) and cyan (C) inks with the proportion of 1:1 is identical to the color tone expressed by the blue (B) ink discharged in volume 1 (same volume as the magenta (M) ink, or cyan (M) ink).

As compared to the ink recording head for comparison, the color tones produced by this ink recording head from the secondary colors ((i) yellow (Y) and magenta (M), (ii) yellow (Y) and cyan (C), (iii) cyan (C) and magenta (M)) may be each expressed through the ink recording head according to this embodiment by a single color ink (red (R), green (G), blue (B)). Furthermore, the total ink volume of the ink recording head according to this embodiment may be reduced to one-half (approximately 50%) of that of the compared example.

The ink recording head according to this embodiment may decrease the total ink volume, effectively suppressing the occurrence of color smearing.

The ink recording head according to this embodiment thus achieving reduction of the total ink volume may conduce to shorter drying time. This may also be a contributing factor that suppresses the occurrence of color smearing.

This embodiment, by shortening drying time, may advantageously afford high-speed printing.

The ink recording head according to this embodiment may be capable of producing desired color tones with smaller volumes of inks than required by the ink recording head for comparison, contributing to reduction of running costs.

The printing apparatus according to the embodiment of the present disclosure may be further characterized in that the ink recording head 10 also includes the recording head 10 (K) that records the black (K) ink, and the control device prompts the ink recording head 10 to record the black (K) ink for a portion of the three primary colors mixed in an equal volume.

According to the above configuration, this embodiment further providing the recording head 10 (K) may achieve greater reduction of the total ink volume. This advantageous effect may be attained because the color tone produced by discharging the three primary color inks, the yellow (Y), magenta (M), and cyan (C) inks with the proportion of 1:1:1 is identical to the color tone expressed by the black (K) color ink discharged in volume 1 (same volume as the yellow (Y), magenta (M), or cyan (C) ink).

According to this embodiment further providing the recording head 10 (K), the color tone to be expressed by a tertiary color (of (i) yellow (Y), magenta (M), and cyan (C)) may be expressed by a single color ink (black (K)), in contrast to the ink recording head for comparison solely consisting of the recording heads that record the inks of yellow (Y), magenta (M), and cyan (C). Furthermore, the total ink volume of the ink recording head according to this embodiment may be reduced to one-third (approximately 33%) of that of the compared example.

Thus, this embodiment further providing the recording head 10 (K) may achieve greater reduction of the total ink volume, more effectively suppressing the occurrence of color smearing.

The embodiment further providing the recording head 10 (K) may achieve reduction of the total ink volume, thereby conducing to even shorter drying time. This may also be a contributing factor that suppresses the occurrence of color smearing.

More advantageously, this embodiment further providing the recording head 10 (K) may conduce to even shorter drying time, allowing the printing to be performed at further higher speeds.

More advantageously, this embodiment further providing the recording head 10 (K) may contribute to greater reduction of running costs.

The printing apparatus according to the embodiment of the present disclosure may be further characterized in that the ink recording head 10 has recording heads that record the inks of yellow (Y), magenta (M), cyan (C), red (R), green (G), blue (B), and black (K). The printing apparatus thus characterized may successfully exert the advantageous effects described so far.

The printing apparatus according to the embodiment of the present disclosure may be further characterized in that the ink recording head includes recording heads that record inks of lighter colors of yellow (Y), magenta (M), and cyan (C) (LY, LM, LC) and recording heads that record inks of lighter colors of red (R), green (G), blue (B), and black (K) (LR, LG, LB, LK). The printing apparatus thus characterized may successfully exert the advantageous effects described so far.

The printing apparatus according to the embodiment of the present disclosure may be further characterized in that the control device, based on information pertinent to discharge volumes of the yellow (Y), magenta (M), cyan (C), red (R), green (G), blue (B), and black (K) inks required to produce a predetermined color tone, prompts the ink recording head 10 to discharge these color inks. The printing apparatus thus characterized may successfully exert the advantageous effects described so far.

The printing apparatus according to the embodiment of the present disclosure may be further characterized in that the control device obtains information pertinent to the color inks required to produce a predetermined color tone, the control device prompts the ink recording head 10 to discharge, in place of the yellow (Y) and magenta (M) inks, the red (R) ink when the information obtained includes information indicating discharge of the yellow (Y) and magenta (M) inks, the control device prompts the ink recording head 10 to discharge, in place of the yellow (Y) and cyan (C) inks, the green (G) ink when the information obtained includes information indicating discharge of the yellow (Y) and cyan (C) inks, and the control device prompts the ink recording head 10 to discharge, in place of the cyan (C) and magenta (M) inks, the blue (B) ink when the information obtained includes information indicating discharge of the cyan (C) and magenta (M) inks.

The printing apparatus according to the embodiment of the present disclosure may be further characterized in that the control device controls the ink recording head 10 so that the color tone produced by discharging the yellow (Y) and magenta (M) inks with the proportion of 1:1 in the predetermined total volume (a) per unit area of the recording target surface is expressed by the red (R) ink discharged in one-half of the predetermined volume (a) per unit area.

The printing apparatus according to the embodiment of the present disclosure may be further characterized in that the control device controls the ink recording head 10 so that the color tone produced by discharging the yellow (Y) and cyan (C) inks with the proportion of 1:1 in the predetermined total volume (b) per unit area of the recording target surface is expressed by the green (G) ink discharged in one-half of the predetermined volume (b) per unit area.

The printing apparatus according to the embodiment of the present disclosure may be further characterized in that the control device controls the ink recording head 10 so that the color tone produced by discharging the cyan (C) and magenta (M) inks with the proportion of 1:1 in the predetermined total volume (c) per unit area of the recording target surface is expressed by the blue (B) ink discharged in one-half of the predetermined volume (c) per unit area.

The printing apparatus according to the embodiment of the present disclosure may be further characterized in that the control device controls the ink recording head 10 so that the color tone produced by discharging the yellow (Y), magenta (M), and cyan (C) inks with the proportion of 1:1:1 in the predetermined total volume (d) per unit area of the recording target surface is expressed by the black (K) ink discharged in one-third of the predetermined volume (d) per unit area.

The printing method according to the embodiment of the present disclosure is a printing method of using the printing apparatus equipped with the ink recording head 10 and operable to print an optional color by way of color separation into three primary colors, wherein when producing a medium color tone by mixing inks of two colors among the three primary colors, a single color ink that exhibits the medium color tone of the two colors is used.

The present disclosure is not necessarily limited to the embodiment described so far and may be carried out in many other forms. The technical scope of the present disclosure encompasses any modifications within the technical scope defined by the appended claims and embodiments obtained by variously combining the technical means disclosed herein.

### INDUSTRIAL APPLICABILITY

The present disclosure may be useful in a variety of printing apparatuses that perform full-color printing.

### DESCRIPTION OF REFERENCE SIGN

10: ink recording head
10(Y): recording head that records yellow (Y) ink
10(M): recording head that records magenta (M) ink
10(C): recording head that records cyan (C) ink
10(R): recording head that records red (R) ink
10(G): recording head that records green (G) ink
10(B): recording head that records blue (B) ink
10(K): recording head that records black (K) ink
20: multilayered body
20(Y): yellow (Y) ink layer
20(M): magenta (M) ink layer
20(C): cyan (C) ink layer
20(R): red (R) ink layer
20(G): green (G) ink layer
20(B): blue (B) ink layer
20(K): black (K) ink layer
100: recording target

1. A printing apparatus, comprising:
an ink recording head; and
a controller configured to control the ink recording head, the printing apparatus being operable to print an optional color by way of color separation into three primary colors, wherein
the ink recording head comprises recording heads configured to record inks of the three primary colors and further comprises recording heads configured to record inks that exhibit medium color tones produced by mixing inks of two colors among the three primary colors, and
the controller, when the medium color tone is produced by mixing inks of two colors among the three primary colors, prompts the ink recording head to use a single color ink among the inks that exhibit the medium color tone of the two colors.

2. The printing apparatus according to claim 1, wherein
the ink recording head comprises a recording head configured to record an ink of black (K), and
the controller prompts the ink recording head to use the ink of black (K) when a color tone is produced by mixing the three primary colors in an equal volume.

3. The printing apparatus according to claim 1, wherein
the ink recording head comprises recording heads configured to record inks of yellow (Y), magenta (M), cyan (C), red (R), green (G), blue (B), and black (K).

4. The printing apparatus according to claim 1, wherein the ink recording head comprises:
recording heads configured to record inks of lighter colors (LY, LM, LC) of yellow (Y), magenta (M), and cyan (C); and
recording heads configured to record inks of lighter colors (LR, LG, LB, LK) of red (R), green (G), blue (B), and black (K).

5. The printing apparatus according to claim 3, wherein
the controller, based on information pertinent to discharge volumes of the inks of yellow (Y), magenta (M), cyan (C), red (R), green (G), blue (B), and black (K) required to produce a predetermined color tone, prompts the ink recording head to discharge the inks of the respective colors.

6. The printing apparatus according to claim 5, wherein
the controller obtains information pertinent to the inks of the respective colors required to produce a predetermined color tone,
the controller prompts the ink recording head to discharge, in place of the inks of yellow (Y) and magenta (M), the ink of red (R) when the information obtained includes information indicating discharge of the inks of yellow (Y) and magenta (M),
the controller prompts the ink recording head to discharge, in place of the inks of yellow (Y) and cyan (C), the ink of green (G) when the information obtained includes information indicating discharge of the inks of yellow (Y) and cyan (C), and
the controller prompts the ink recording head to discharge, in place of the inks of cyan (C) and magenta (M), the ink of blue (B) when the information obtained includes information indicating discharge of the inks of cyan (C) and magenta (M).

7. The printing apparatus according to claim 6, wherein
the controller controls the ink recording head so that a color tone produced by discharging the inks of yellow (Y) and magenta (M) on a recording target surface with the proportion of 1:1 until the amount in total of the inks discharged per unit area of the recording target surface reaches a predetermined volume (a) is expressed by setting the amount in total of the ink of red (R) discharged on the recording target surface per unit area to one-half of the predetermined volume (a).

8. The printing apparatus according to claim 6, wherein
the controller controls the ink recording head so that a color tone produced by discharging the inks of yellow (Y) and cyan (C) on a recording target surface with the proportion of 1:1 until the amount in total of the inks discharged per unit area of the recording target surface reaches a predetermined volume (b) is expressed by setting the amount in total of the ink of green (G) discharged on the recording target surface per unit area to one-half of the predetermined volume (b).

9. The printing apparatus according to claim 7, wherein
the controller controls the ink recording head so that a color tone produced by discharging the inks of cyan (C) and magenta (M) on a recording target surface with the proportion of 1:1 until the amount in total of the inks discharged per unit area of the recording target surface reaches a predetermined volume (c) is expressed by setting the amount in total of the ink of blue (B) discharged on the recording target surface per unit area to one-half of the predetermined volume (c).

10. The printing apparatus according to claim 6, wherein
the controller controls the ink recording head so that a color tone produced by discharging the inks of yellow (Y), magenta (M), and cyan (C) on a recording target surface with the proportion of 1:1:1 until the amount in total of the inks discharged per unit area of the recording target surface reaches a predetermined volume (d) is expressed by setting the amount in total of the ink of black (K) discharged on the recording target surface per unit area to one-third of the predetermined volume (d).

11. A printing method of using a printing apparatus comprising an ink recording head and operable to print an optional color by way of color separation into three primary colors, wherein
when producing a medium color tone by mixing inks of two colors among the three primary colors, a single color ink that exhibits the medium color tone of the two colors is used.

12. The printing apparatus according to claim 2, wherein
the ink recording head comprises recording heads configured to record inks of yellow (Y), magenta (M), cyan (C), red (R), green (G), blue (B), and black (K).

13. The printing apparatus according to claim 12, wherein
the controller, based on information pertinent to discharge volumes of the inks of yellow (Y), magenta (M), cyan (C), red (R), green (G), blue (B), and black (K) required to produce a predetermined color tone, prompts the ink recording head to discharge the inks of the respective colors.

14. The printing apparatus according to claim 13, wherein
the controller obtains information pertinent to the inks of the respective colors required to produce a predetermined color tone,
the controller prompts the ink recording head to discharge, in place of the inks of yellow (Y) and magenta (M), the ink of red (R) when the information obtained includes information indicating discharge of the inks of yellow (Y) and magenta (M),
the controller prompts the ink recording head to discharge, in place of the inks of yellow (Y) and cyan (C), the ink of green (G) when the information obtained includes information indicating discharge of the inks of yellow (Y) and cyan (C), and
the controller prompts the ink recording head to discharge, in place of the inks of cyan (C) and magenta (M), the ink of blue (B) when the information obtained includes information indicating discharge of the inks of cyan (C) and magenta (M).

15. The printing apparatus according to claim 14, wherein
the controller controls the ink recording head so that a color tone produced by discharging the inks of yellow (Y) and magenta (M) on a recording target surface with the proportion of 1:1 until the amount in total of the inks discharged per unit area of the recording target surface reaches a predetermined volume (a) is expressed by setting the amount in total of the ink of red (R) discharged on the recording target surface per unit area to one-half of the predetermined volume (a).

16. The printing apparatus according to claim 14, wherein
the controller controls the ink recording head so that a color tone produced by discharging the inks of yellow (Y) and cyan (C) on a recording target surface with the proportion of 1:1 until the amount in total of the inks discharged per unit area of the recording target surface reaches a predetermined volume (b) is expressed by setting the amount in total of the ink of green (G) discharged on the recording target surface per unit area to one-half of the predetermined volume (b).

17. The printing apparatus according to claim 15, wherein
the controller controls the ink recording head so that a color tone produced by discharging the inks of cyan (C) and magenta (M) on a recording target surface with the proportion of 1:1 until the amount in total of the inks discharged per unit area of the recording target surface reaches a predetermined volume (c) is expressed by setting the amount in total of the ink of blue (B) discharged on the recording target surface per unit area to one-half of the predetermined volume (c).

18. The printing apparatus according to claim 14, wherein
the controller controls the ink recording head so that a color tone produced by discharging the inks of yellow (Y), magenta (M), and cyan (C) on a recording target surface with the proportion of 1:1:1 until the amount in total of the inks discharged per unit area of the recording target surface reaches a predetermined volume (d) is expressed by setting the amount in total of the ink of black (K) discharged on the recording target surface per unit area to one-third of the predetermined volume (d).

19. The printing apparatus according to claim 2, wherein the ink recording head comprises:
recording heads configured to record inks of lighter colors (LY, LM, LC) of yellow (Y), magenta (M), and cyan (C); and
recording heads configured to record inks of lighter colors (LR, LG, LB, LK) of red (R), green (G), blue (B), and black (K).
